(19) United States
(12) Patent Application Publication
(10) Pub. No.: US 2011/0049879 A1
(43) Pub. Date: Mar. 3, 2011

(54) CLAMP SUITABLE FOR INCREASING THE FATIGUE LIFE OF THE BUTT WELDS OF A PIPE PRESSURE VESSEL WHICH IS SUBSEQUENTLY BENT

(76) Inventor: PATRICK JOHN FITZPATRICK, Calgary (CA)

(21) Appl. No.: 12/855,970

(22) Filed: Aug. 13, 2010

Related U.S. Application Data
(60) Provisional application No. 61/238,852, filed on Sep. 1, 2009.

(51) Int. Cl. F16L 25/00

(52) U.S. Cl. 285/420

(57) ABSTRACT

A pipe clamp for affixing to a pipe subjected to bending to minimize fatigue for a butt weld in the pipe. The pipe clamp includes an inside clamp segment and an outside clamp segment each having a semi-cylindrical shape, a first end and a second end. An inside surface of the inside clamp segment is substantially smooth for permitting slippage of an outside surface of the pipe with respect to the inside surface of the clamp segment. The outside clamp segment has an inside surface that defines a friction element. The friction element is for gripping an outside surface of the pipe to which the outside clamp segment is affixed. A clamp mechanism is provided for securing the inside clamp segment to the outside clamp segment.

### CROSS REFERENCE TO RELATED APPLICATIONS

This application claims the priority of U.S. Provisional Patent Application No. 61/238,852 entitled “CLAMP SUITABLE FOR INCREASING THE FATIGUE LIFE OF THE BUTT WELDS OF A PIPE PRESSURE VESSEL WHICH IS SUBSEQUENTLY BENT,” filed Sep. 1, 2009, the contents of which are hereby incorporated by reference.

### FIELD OF THE INVENTION

The invention relates to a pipe clamp. More particularly, the invention relates to a pipe clamp for locating over a butt weld in a length of pipe to be subjected to bending forces to protect against excessive strain in the weld area.

### BACKGROUND OF THE INVENTION

The application area is the storage of natural gas (CNG) or other fluids or gases under pressure in pressure vessels comprised of very long lengths (generally over 1 km and under 30 km) of steel pipe. For practical management, these lengths of pipe are coiled on a steel spool by a simple winding process. The result is termed a “Coselle®”. Many Coselles® may be installed in the hold of a ship. A Coselle® carrying ship loads gas in a first port and discharges in a second port. A Coselle® carrying ship may make ˜60 cycles per year. The pressurizing and de-pressurizing associated with the loading and unloading of gas induces major stress changes in the steel of the Coselles®, which could possibly result in fatigue cracking. The long lengths of pipe are necessarily constructed by welding shorter lengths of pipe together. The welds are more sensitive to fatigue problems than the parent metal of the pipe.

It has become apparent during prototype Coselle® testing where 6″ pipe was wound about a hub of ˜9 meters diameter, that higher than average strains were being experienced in the outside wall of the pipe at the heat affected zone (HAZ) interface of the circumferential joining welds (butt welds) contained in the pipe. These high localized strains, (approximately 6% as opposed to approximately 1.8% average) shortened the fatigue life of the weld and are responsible for limiting the ultimate fatigue life of the Coselle®. As a result it was necessary to operate at a lower working pressure than would be allowed if the fatigue life were extended, which reduced the gas volume and raised the overall cost of gas transport.

In addition to exceptional strain, the weld properties may also be adversely affected by ovalization of the pipe during the bending process. At the four points of high and low curvature of the oval, stress is increased during the pressurization process and this will reduce fatigue life, particularly for the butt welds.

In summary it is economically important to ensure a long fatigue life for the butt welds in the Coselle® pipe pressure vessel, to protect against both excessive strain of the heat affected zone and ovalization, both induced by the coiling process. This is achieved by the following clamp apparatus.

### SUMMARY OF THE INVENTION

The solution chosen to the excessive strain problem is to severely limit the bending of the pipe and to prevent ovalling in the region of butt welds and simultaneously to largely prevent strain in the outside of the pipe. This may be accomplished by applying a clamp to a pipe over a butt weld. The following describes the clamp that was developed and tested successfully. However, other embodiments of a clamp could be derived to accomplish the desired results.

An example clamp has a length of 300 mm. Preferably, the clamp has a length of 1.75 external diameters of pipe, but larger or smaller clamps could also be used. The clamp functions as a reinforcing brace composed of two semi-circular, straight half-cylinders of steel bolted together on both sides of the pipe. The clamp is made up of a first half-cylinder located on the outside of the bend of the pipe, and is made up of a second half-cylinder located on the inside of a bend of the pipe. The inside radius of curvature of both clamp half-cylinders is preferably equal to the outside radius of the pipe. The thickness of the clamp is such that the clamp is not plastically bent by the bending forces.

The rigidity of the clamp limits bending of the pipe in the region of the weld and, with its special features described below, ensures that the localized axial strains in the outside wall of the pipe remain low during and after winding. Simultaneously, the clamp ensures that ovalization is minimized.

The outer half of the clamp contains scoring on its inside to ensure bonding with the outside surface of the pipe. The primary mechanism by which the clamp works to limit strain in the outside of the pipe is inter-particle static friction on the surface of the pipe, and this is the reason for providing scoring. Scoring (which preferably resembles threading) has a pitch such that the ridges will bite slightly into the pipe and an overall contact area so as not to damage the pipe by compression during the bending process. The inside half of the clamp is not scored and in fact, slippage on the inside of the pipe is not undesirable.

In the vicinity of the pipe weld, the pipe is almost completely surrounded by the rigid clamp. Therefore, ovalization of the pipe is almost completely prevented. However, the presence of the clamp can induce serious ovalling, even kinking, of the pipe at both ends of the clamp as the pipe is wound. To address this problem, two shape modifications to the inner half of the clamp are made. First, the two ends of the inside half of the clamp are ground away in a specific pattern to ease the concentration of force on the pipe at the ends of the clamp. The preferred shape of the metal removed is a semicircle of radius equal to the radius of the pipe, but approximations to this semi-circle may be used. Secondly, ovalization in the vicinity of the clamp may be further reduced by grinding away some of the thickness of the inside half of the clamp so that it is significantly thinner at its outside edges than at its center (roughly half the thickness is preferred). The reason is to further minimize the transverse force on the pipe when the clamp first hits the underlying pipes beyond the relief provided by the removed semicircles.

While both halves of the clamp have their radii of curvature identical to the outside of the pipe, the two halves of the clamp do not comprise a complete 360° turn. When bolts are fully tightened, the two halves of the clamp preferably do not touch each other so that the full force of the clamp halves is impressed on the pipe.

When the bending of the pipe is complete, the clamp is removed as follows: the inward force of the pipe is reduced by a very slight reverse turn of the spooling hub. The clamp is then disassembled. The outside half of the clamp is removed and then the inside half of the clamp is rotated around the pipe and lifted off. To facilitate the rotation, the bottom half of the clamp preferably has a reasonably uniform or reduced thickness profile in the rotary sense.

In use, the clamp halves are very strongly tightened up on the pipe by a series of bolts. The scoring and the tightening threads in the bolt holes wear down with use so that the clamp will have to be replaced after a number of uses.

Both halves of the clamp have a small channel of metal removed from the inside centers of the halves in the hoop direction to accommodate the weld bead of the butt weld. This obviates the need to grind the weld.

The clamp is preferably made of steel with a Young's Modulus closely equal to that of the steel of the pipe. The yield stress of the steel used in the clamp should be at least that of the pipe and up to 40% greater.

A first embodiment of the invention is rigid and heavy (about 200 lbs weight). This embodiment totally protects the weld and even with 1,000,000 cycles no fatigue damage was found to have occurred to the weld. The first embodiment is, however, cumbersome to manipulate. A second embodiment is a lighter version (about 40 lbs).

The clamp described above in detail is a preferred embodiment of a device to minimize the strain in the outer edge of a pipe and to minimize ovalling in the region of a butt weld while being bent around a coil (FIG. 9). Other embodiments may also be used.

For example, the clamping force may be provided not by bolts, but by external hydraulic pressure. The halves of the clamp may be held together by welding or binding with wire. Alternatively the clamp halves may be significantly heated before being applied and welded. The clamping force would be due to metallic contraction as the clamp cools. Alternatively, the two clamp halves could be drawn together by a buckling mechanism, with or without the assistance of a hydraulic press.

Alternative means of creating friction may be developed to eliminate the need for the threading, such as metal to metal adhesives, low temperature metal alloy solders, a layer of sharp particles of a substance harder than steel, such as silicon carbide, etc.

Strips of steel, centered on the butt weld may be welded axially on the pipe.

The butt weld and adjacent areas may be wound with a strong material that is bonded to the pipe. The material may be steel wire, e-glass, Kevlar or other material that could be permanently bonded to the pipe, which would reduce the induced winding strains and/or reduce ovalization.

In a further embodiment, a section of pipe whose ID is the same as the OD of the main pipe may be slipped onto the main pipe before the welding operation. The section of pipe may then be centered over the butt weld. This pipe section resembles the clamp but may remain in place after the main pipe is bent.

Alternatively, a small pipe section or other steel structure may be inserted inside the main pipe and restrained so as to be centered on the butt weld. The small section of pipe remains in place after welding and bending.

### BRIEF DESCRIPTION OF THE DRAWINGS

FIG. 1 is an exploded perspective view of the pipe weld clamp of the invention including an inside clamp segment and an outside clamp segment;

FIG. 2 is a partial cross-sectional view of the pipe weld clamp of FIG. 1 shown installed within a pipe;

FIG. 3 is a perspective view of the inside pipe clamp segment of FIG. 1;

FIG. 4 is a schematic view of an outside surface of the inside pipe clamp segment of FIG. 1;

FIG. 5 is a schematic view of an inside surface of the inside pipe clamp segment of FIG. 1;

FIG. 6 is a perspective view of the outside pipe clamp segment of FIG. 1;

FIG. 7 is a schematic view of an outside surface of the inside pipe clamp segment of FIG. 1;

FIG. 8 is a schematic view of an inside surface of the inside pipe clamp segment of FIG. 1;

FIG. 9 is a perspective view of the pipe of FIG. 2 wound on a core.

### DETAILED DESCRIPTION OF THE PREFERRED EMBODIMENTS

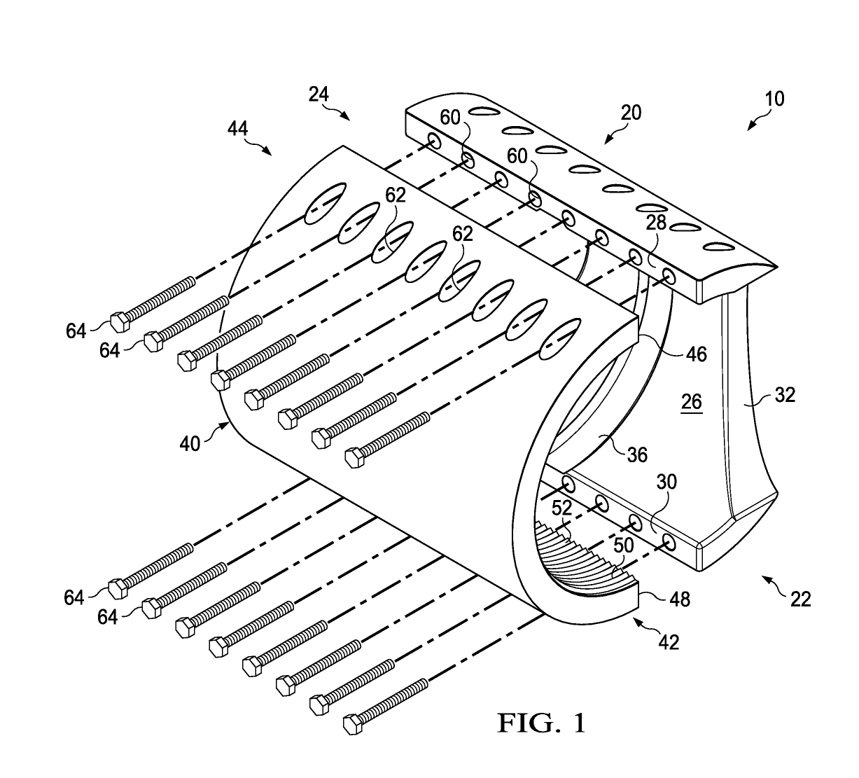

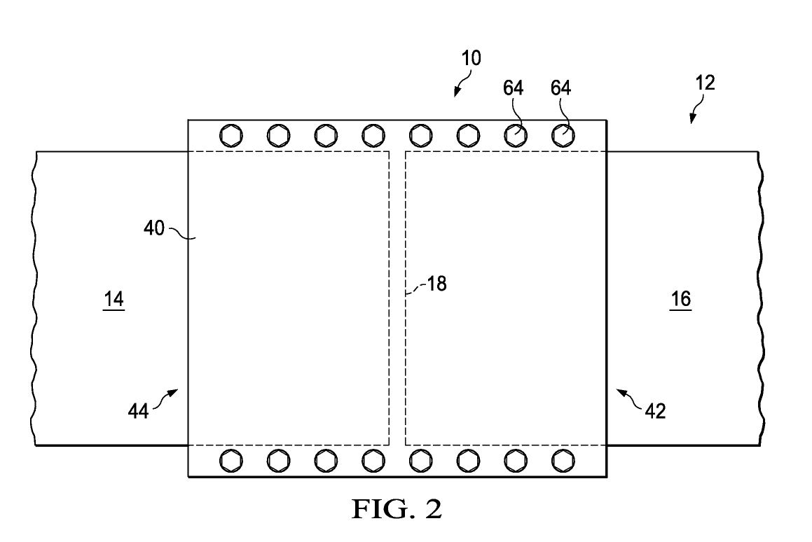

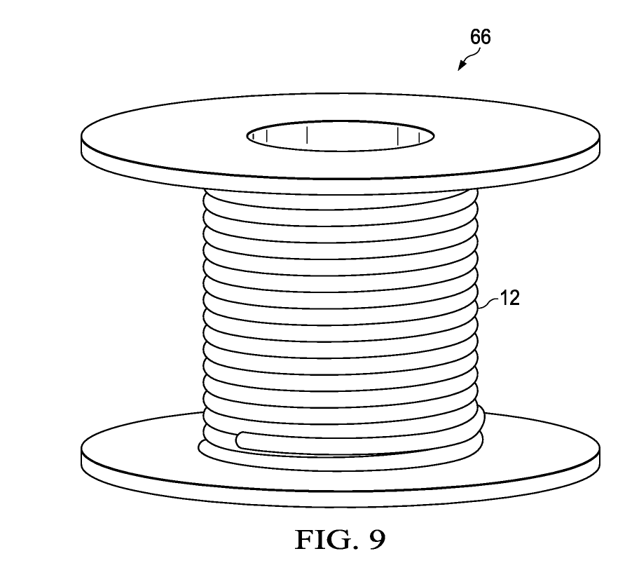

Referring now to FIGS. 1 and 2, shown is pipe clamp designated generally 10. Pipe clamp 10 is for affixing to pipe 12 (FIGS. 2, 9). Pipe 12 consists of first pipe segment 14 and second pipe segment 16. First pipe segment 14 and second pipe segment 16 are joined together via butt weld 18. Pipe clamp 10 is provided to protect butt weld 18 from excessive strain of a heat affected zone and ovallization, both induced by a coiling process of pipe 12, as shown in FIG. 9.

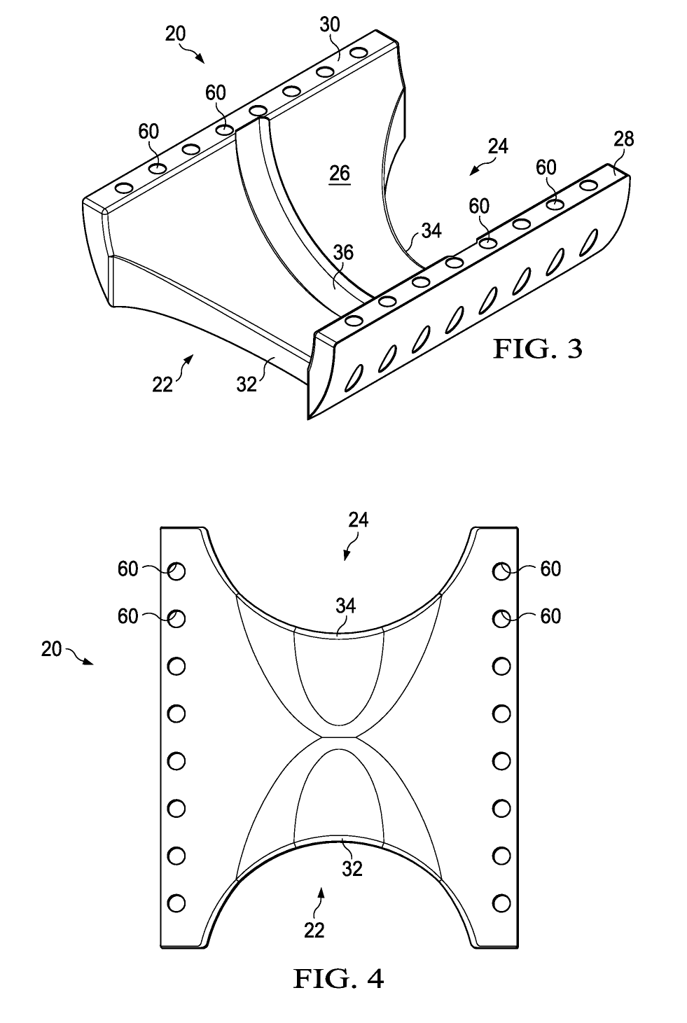

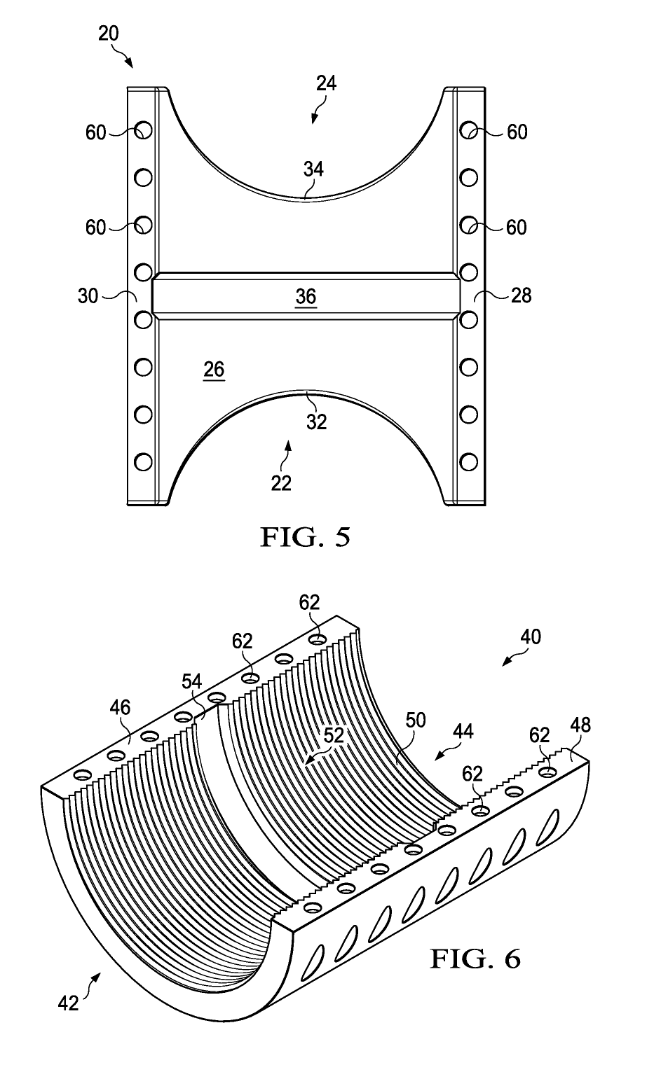

Pipe clamp 10 consists of inside clamp segment 20 (FIGS. 1, 3-5). Inside clamp segment 20 has a semi-cylindrical shape and has a first end 22 and a second end 24. Inside clamp segment 20 additionally has an inside surface 26, an upper lengthwise mating surface 28, and a lower lengthwise mating surface 30. First end 22 defines first stress relief area 32. Second end 24 defines second stress relief area 34 (FIGS. 3-5).

Inside clamp segment 20 preferably defines radial groove 36 for receiving butt weld 18 when inside clamp segment 20 is positioned on pipe 12. Inside surface 26 of inside clamp segment 20 is preferably substantially smooth for permitting slippage of an outside surface of pipe 12 with respect to inside surface 26 of inside clamp segment 20.

In one embodiment, first stress relief area 32 defines a first semi-circle and second stress relief area 34 defines a second semi-circle. The first semi-circle defined by first stress relief area 32 and a second semi-circle defined by the second stress relief area 34 preferably each have a radius equal to the radius of pipe 12.

In one embodiment, as best seen in FIG. 4, a thickness of inside clamp segment 20 proximate first end 22 and second end 24 is less than a thickness of inside clamp segment 20 at a center of inside clamp segment 20.

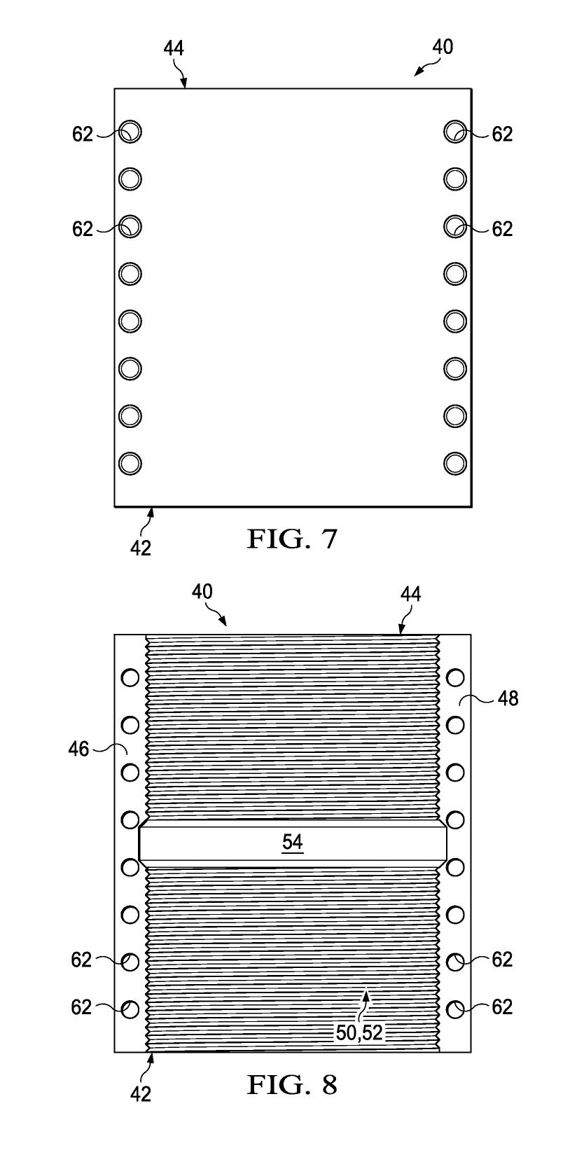

Pipe clamp 10 additionally consists of outside clamp segment 40 (FIGS. 1, 2, 6-8), having a semi-cylindrical shape. Outside clamp segment 40 has a first end 42 and a second end 44. Outside clamp segment 40 additionally defines an upper lengthwise mating surface 46 and a lower lengthwise mating surface 48. Outside clamp segment 40 additionally has an inside surface 50. Preferably, inside surface 50 defines a friction element 52. Friction element 52 is for gripping an outside surface of pipe 12.

Outside clamp segment 40 additionally preferably defines radial groove 54 (FIGS. 6, 8) for receiving butt weld 18 when outside clamp segment 40 is located on pipe 12. In a preferred embodiment, friction element 52 is made up of scoring on inside surface 50. More preferably, scoring is made up of threads. An example thread has a depth of 0.77″ and a peak to peak measurement of 0.166″. Friction element 52 may also be created through use of metal adhesives, low temperature metal alloy solders, or by a layer of hard particles affixed to inside surface 50.

Preferably, upper lengthwise mating surface 28 and lower lengthwise mating surface 30 of inside clamp segment 20 define a plurality of orifices 60. Additionally, in a preferred embodiment, upper lengthwise mating surface 46 and lower lengthwise mating surface 48 of outside clamp segment 40 defines a plurality of orifices 62. Plurality of bolts 64 (FIGS. 1, 2) are provided for locating in plurality of orifices 60 defined by upper lengthwise mating surface 28 and lower lengthwise mating surface 30 of inside clamp segment 20. Bolts 64 additionally locate within plurality of orifices 62 defined by upper lengthwise mating surface 46 and lower lengthwise mating surface 48 of outside clamp segment 40. Bolts 64 secure inside clamp segment 20 to outside clamp segment 40.

In a preferred embodiment, inside clamp segment 20 and outside clamp segment 40 have a thickness such that pipe clamp 10, i.e., inside clamp segment 20 and outside clamp segment are not plastically deformed by bending forces when pipe 12 is bent after pipe clamp 10 is secured to pipe 12.

In a preferred embodiment, inside clamp segment 20 and outside clamp segment 40 have a radius of curvature substantially equal to a radius of curvature of pipe 12. Preferably, inside clamp segment 20 and outside clamp segment 40 are sized such that when inside clamp segment 20 and outside clamp segment 40 are fully tightened about pipe 12, upper lengthwise mating surface 28 of inside clamp segment 20 and upper lengthwise mating surface 46 of outside clamp segment 40 do not touch one another. Similarly, it is preferred that lower lengthwise mating surface 30 of inside clamp segment 20 and lower lengthwise mating surface 48 of outside clamp segment 40 do not touch one another so that the full compressive force of inside clamp segment 20 and outside clamp segment 40 is impressed upon pipe 10 when bolts 64 are tightened.

Other methods of compressing pipe 12 within pipe clamp 10 are also contemplated, including forcing inside clamp segment 20 and outside clamp segment 40 together with hydraulic pressure. Inside clamp segment 20 and outside clamp segment 40 may also be forced together with tightened wire. Further, inside clamp segment 20 and outside clamp segment 40 may be forced together by metallic cooling of inside clamp segment 20 and outside clamp segment 40.

It is also contemplated that a strong material bound to pipe 12 may be wound around pipe 12 to prevent ovalling. Contemplated materials include wire, e-glass, and Kevlar®. It is further contemplated that a pipe segment may be centered over butt weld 18. It is additionally contemplated that pipe segment may be centered under butt weld 18.

When the bending of pipe 12 is complete, clamp 10 is removed as follows: the inward force of pipe 12 is reduced by a very slight reverse turn of the spooling hub 66. Clamp 10 is then disassembled. Outside clamp segment 40 is removed and then inside clamp segment 20 of the clamp 10 is rotated around pipe 12 and lifted off. To facilitate the rotation, the bottom half of the clamp 10 preferably has a reasonably uniform or reduced thickness profile in the rotary sense.

In use, clamp segments 20, 40 are very strongly tightened up on pipe 12 by a series of bolts 64. Other clamp mechanisms may also be used. Friction element 52, e.g., scoring, and the tightening threads in the bolt holes 60 wear down with use so that clamp 10 will have to be replaced after a number of uses.

Both segments 20, 40 of clamp 10 have a small channel or radial groove 36 of metal removed from the inside surface 26 of clamp segment 20 and inside surface 50 of clamp segment 40 in the hoop direction to accommodate the weld bead of weld 18. This obviates the need to grind the weld 18.

The clamp 10 is preferably made of steel with a Young's Modulus closely equal to that of the steel of pipe 12. The yield stress of the steel used in the clamp 10 should be at least that of pipe 12 and up to 40% greater.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the specification.

What is claimed is:

1. A pipe clamp for affixing to a pipe subjected to bending, said pipe clamp comprising:
an inside clamp segment having a semi-cylindrical shape, a first end and a second end;
said first end defining a first stress relief area and said second end defining a second stress relief area;
an outside clamp segment having a semi-cylindrical shape;
a clamp mechanism for securing said inside clamp segment to said outside clamp segment.

2. The pipe clamp according to claim 1 wherein:
at least one of said inside clamp segment and said outside clamp segment defines a radial groove for receiving a butt weld when said clamp segments are located on the pipe.

3. The pipe clamp according to claim 1 wherein:
an inside surface of said inside clamp segment is substantially smooth for permitting slippage of an outside surface of the pipe with respect to said inside surface.

4. The pipe clamp according to claim 1 wherein:
said first stress relief area defines a first semi-circle; and
said second stress relief area defines a second semi-circle.

5. The pipe clamp according to claim 4 wherein:
said first semi-circle and said second semi-circle have a radius equal to that of the pipe to which said inside clamp segment and said outside clamp segment are attached.

6. The pipe clamp according to claim 1 wherein:
a thickness proximate said first end of said inside clamp segment and said second end of said inside clamp segment is less than a thickness of said inside clamp segment at a center of said inside clamp segment.

7. The pipe clamp according to claim 1 wherein:
said outside clamp segment defines a friction element, said friction element for gripping an outside surface of the pipe to which said outside clamp segment is affixed.

8. The pipe clamp according to claim 7 wherein:
said friction element is scoring on an inside surface of said outside clamp segment.

9. The pipe clamp according to claim 8 wherein:
wherein said scoring is comprised of threads.

10. The pipe clamp according to claim 1 wherein:
wherein said inside clamp segment defines an upper lengthwise mating surface and a lower lengthwise mating surface;
wherein said outside clamp segment defines an upper lengthwise mating surface and a lower lengthwise mating surface;
wherein said upper lengthwise mating surface and said lower lengthwise mating surface of said inside clamp segment defines a plurality of orifices;
wherein said upper lengthwise mating surface and said lower lengthwise mating surface of said outside clamp segment defines a plurality of orifices; and
said clamp mechanism is comprised of a plurality of bolts for locating in said plurality of orifices of said upper lengthwise mating surface and said lower lengthwise mating surface of said inside clamp segment and for locating in said plurality of orifices of said upper lengthwise mating surface and said lower lengthwise mating surface of said outside clamp segment for securing said inside clamp segment to said outside clamp segment.

11. The pipe clamp according to claim 1 wherein:
said inside clamp segment and said outside clamp segment have a radii of curvature substantially equal to a radius of curvature of the pipe.

12. A pipe clamp for affixing to a pipe subjected to bending, said pipe clamp comprising:
an inside clamp segment having a semi-cylindrical shape, a first end and a second end;
an inside surface of said inside clamp segment that is substantially smooth for permitting slippage of an outside surface of the pipe with respect to said inside surface of said inside clamp segment;
an outside clamp segment having a semi-cylindrical shape, a first end and a second end;
said outside clamp segment defines a friction element for gripping said outside surface of the pipe to which said outside clamp segment is affixed;
a clamp mechanism for securing said inside clamp segment to said outside clamp segment.

13. The pipe clamp according to claim 12 wherein:
at least one of said inside clamp segment and said outside clamp segment defines a radial groove for receiving a butt weld when said clamp segments are located on the pipe.

14. The pipe clamp according to claim 12 wherein:
said first end of said inside pipe clamp segment defines a first stress relief area and said second end defines a second stress relief area.

15. The pipe clamp according to claim 14 wherein:
said first stress relief area defines a first semi-circle; and
said second stress relief area defines a second semi-circle.

16. The pipe clamp according to claim 15 wherein:
said first semi-circle and said second semi-circle have a radius equal to that of the pipe to which said inside clamp segment and said outside clamp segment are attached.

17. The pipe clamp according to claim 12 wherein:
a thickness proximate said first end of said inside clamp segment and said second end of said inside clamp segment is less than a thickness of said inside clamp segment at a center of said inside clamp segment.

18. The pipe clamp according to claim 12 wherein:
said friction element is scoring on an inside surface of said outside clamp segment.

19. The pipe clamp according to claim 18 wherein:
wherein said scoring is comprised of threads.

20. The pipe clamp according to claim 12 wherein:
wherein said inside clamp segment defines an upper lengthwise mating surface and a lower lengthwise mating surface;
wherein said outside clamp segment defines an upper lengthwise mating surface and a lower lengthwise mating surface;
wherein said upper lengthwise mating surface and said lower lengthwise mating surface of said inside clamp segment defines a plurality of orifices;
wherein said upper lengthwise mating surface and said lower lengthwise mating surface of said outside clamp segment defines a plurality of orifices; and
said clamp mechanism is comprised of a plurality of bolts for locating in said plurality of orifices of said upper lengthwise mating surface and said lower lengthwise mating surface of said inside clamp segment and for locating in said plurality of orifices of said upper lengthwise mating surface and said lower lengthwise mating surface of said outside clamp segment for securing said inside clamp segment to said outside clamp segment.

21. The pipe clamp according to claim 12 wherein:
said inside clamp segment and said outside clamp segment have a radii of curvature substantially equal to a radius of curvature of the pipe.

22. A method of minimizing fatigue for a butt weld of a pipe subjected to bending comprising the steps of:
affixing an inside clamp segment to an outside surface of the pipe proximate the butt weld in the pipe;
affixing an outside clamp segment to said outside surface of the pipe proximate the butt weld in the pipe; and
clamping the pipe with said inside clamp segment and said outside clamp segment to prevent the butt weld from being subjected to bending forces.

23. The method according to claim 22 further comprising:
locating an inside radial groove formed on an inside surface of at least one of said inside clamp segment and said outside clamp segment over the butt weld when locating said clamp segments on the pipe.

24. The method according to claim 22 further comprising:
permitting an inside surface of said inside clamp segment to slip with respect to said outside surface of the pipe.

25. The method according to claim 22 further comprising:
gripping the pipe with said outside clamp segment with a friction element on an inside surface of said outside clamp segment.

26. The method according to claim 22 further comprising:
inserting a plurality of bolts in a plurality of orifices defined by said inside clamp segment and inserting said plurality of bolts in a plurality of orifices of said outside clamp segment for securing said inside clamp segment to said outside clamp segment.
